(19) United States
(12) Patent Application Publication
(10) Pub. No.: US 2014/0238206 A1
(43) Pub. Date: Aug. 28, 2014

(54) MACHINE TOOL EQUIPPED WITH MOVABLE COVER

(71) Applicant: FANUC Corporation, Yamanashi (JP)

(72) Inventor: Naoki SATO, Yamanashi (JP)

(73) Assignee: FANUC Corporation, Yamanashi (JP)

(21) Appl. No.: 14/181,916

(22) Filed: Feb. 17, 2014

(30) Foreign Application Priority Data
Feb. 26, 2013 (JP) 2013-035875

(51) Int. Cl. B23Q 11/08

(52) U.S. Cl. CPC B23Q 11/08
USPC 82/152; 142/55; 409/235

(57) ABSTRACT

The machining space of a machine tool is covered by a cover. A wall section is arranged on the bottom section of the cover of a machine tool, in such a manner that there is a slight gap between the telescopic cover and the side faces of the wall section. Since the gaps between the side faces of the wall section and the side faces of the telescopic cover are small, then it is possible to prevent cutting chips from going into a space beneath the telescopic cover and accumulating under the telescopic cover.

### BACKGROUND OF THE INVENTION

1. Field of the Invention

The present invention relates to a machine tool equipped with a movable cover.

2. Description of the Related Art

The working space of a machine tool is covered with a cover known as a splash guard, in order to prevent cutting chips generated during machining from being scattered outside the machine. The cutting chips generated during machining may accumulate on a telescopic cover which is fixed to a work table, or enter into a gap between a cover (splash guard) and the telescopic cover, or into a space beneath the telescopic cover.

Japanese Patent Application Laid-Open No. 11-277363 discloses a first example of a solution to this, in which cutting chips accumulated on a telescopic cover are swept away by a wiper in coordination with the opening and closing of a door. However, in this method, if machining continues for a long period of time and a situation where the door is not opened and closed continues, then cutting chips simply continue to accumulate, as a result of which the operation of the cover is obstructed. Moreover, with this method, there is a problem in that cutting chips generated during machining enter into a space beneath the splash guard, and it is not possible to prevent the accumulation thereof in the drive parts of the table and saddle (the linear drive guide and feed ball screw), and the vicinity thereof.

A second example of a solution to the foregoing is known in which cutting chips are prevented from entering into the drive parts by covering the gap between the cover (splash guard) and the telescopic cover with a separate cover. However, with this method, a separate component (the separate cover described above) is required and costs increase, so sufficient sealing properties cannot be expected. Moreover, with this method, there is a problem in that cutting chips generated during machining enter into a space beneath the splash guard, and it is not possible to prevent the accumulation thereof in the drive parts of the table and saddle (the linear drive guide and feed ball screw), and the vicinity thereof.

Furthermore, Japanese Patent Application Laid-Open No. 2003-236731 discloses a third example of a solution to the foregoing, in which a groove for receiving cutting chips is provided in the gap between the cover (splash guard) and the telescopic cover, and a cutting chip conveyance apparatus is provided inside this groove. However, with this method, it is necessary to make a robust cover since a cutting chip conveyance apparatus which is heavy in weight is installed a set distance above the bottom surface of the splash guard, and as a result of this, there are problems in that the structure becomes larger, costs increase, and cutting chips enter into the space beneath the groove and accumulate there.

### SUMMARY OF THE INVENTION

An object of the present invention is, in view of the problems of the prior art described above, to provide a machine tool equipped with a movable cover whereby cutting chips can be prevented from entering into a space beneath the splash guard and accumulating in the drive parts of the table and saddle (the linear drive guide and feed ball screw) and the vicinity thereof, while suppressing obstruction of the machine tool.

The machine tool according to the present invention includes: a saddle which is supported on a first guide member provided on a bed and which moves relatively in a first direction with respect to the bed; a table which is supported on a second guide member provided on the saddle and which moves relatively with respect to the saddle in a second direction intersecting with the first direction; a column having a spindle; a cover which covers the periphery of the bed; and a movable cover which is provided on both side faces or one side face in the first direction of the saddle, both ends or one end thereof being fixed to the cover and the movable cover being formed to be able to perform a telescopic motion in synchronization with the movement of the saddle. The cover has a front face cover provided on an opposite side to the column with the table interposed therebetween, side face covers provided to the left and right of the front face cover, and a bottom section which is connected to the bed from the front face cover and the side face covers. The machine tool machines a workpiece by causing a tool installed on the spindle and the workpiece which is set on the table to move relative to each other. In this machine tool, furthermore, a wall section which projects upwards from the bottom section and extends long in the first direction is provided in the bottom section of the cover, inside the movable cover.

The wall section may be arranged to the inside of the movable cover, by making a width of the wall section (a dimension of the wall section in a direction perpendicular to the first direction) slightly smaller than a width of the movable cover (a dimension perpendicular to the telescoping direction of the movable cover).

The wall section may be arranged so as to extend long in the front/rear direction or left/right direction of the machine tool, in the bottom section of the cover.

The wall section may be attached to the bottom section of the cover as a separate member from the cover, or have a structure which is integrated with the cover, or be formed by raising up the bottom section of the cover.

The first direction may be a direction parallel to the side face covers; and a portion of the bottom section of the cover which connects with the side face covers may have an inclined surface which becomes gradually lower from the front towards the rear of the machine tool or from the rear towards the front thereof.

The first direction may be a direction parallel to the side face covers; and portions of the bottom section of the cover which connect respectively with the left and right side face covers may have inclined surfaces, one of which becomes gradually lower from the front towards the rear of the machine tool and the other of which becomes gradually lower from the rear towards the front thereof.

The first direction maybe a direction parallel to the front face cover; and a portion of the bottom section of the cover which connects with the front face cover and a portion of the bottom section of the cover which connects with the side face covers may be separated by the wall section, and the separated portions may each have an inclined surface which is inclined in any direction.

The machine tool may comprise a cutting fluid supply nozzle which supplies cutting fluid to the upper surface of the movable cover which is able to perform a telescopic motion.

A portion of the bottom section of the cover which connects with the front face cover and a portion of the bottom section of the cover which connects with the side face covers may be separated by the wall section, and the machine tool may be provided with cutting fluid supply nozzles which respectively supply cutting fluid to these separated portions.

According to the present invention, it is possible to provide a machine tool equipped with a movable cover whereby cutting chips can be prevented from entering into a space beneath the splashguard and accumulating in the drive parts of the table and saddle (the linear drive guide and feed ball screw) and the vicinity thereof, while suppressing obstruction of the machine tool.

### BRIEF DESCRIPTION OF THE DRAWINGS

The abovementioned and further objects and characteristic features of the present invention will become evident from the following description of the embodiments with reference to the drawings, in which:

FIG. 1 is a top view (schematic drawing) of a first embodiment of a machine tool according to the present invention;

FIG. 2 is an elevation view (schematic drawing) of the machine tool in FIG. 1;

FIG. 3 illustrates examples of the shape of a wall section;

FIG. 4 is a diagram illustrating the use of a wall section to prevent cutting chips from entering into a space beneath the telescopic cover;

FIG. 5 illustrates the directions of the flow of cutting fluid in the machine tool in FIG. 1;

FIG. 6 is a top view (schematic drawing) of a second embodiment of a machine tool according to the present invention;

FIG. 7 is an elevation view (schematic drawing) of the machine tool in FIG. 6; and

FIG. 8 illustrates the directions of the flow of cutting fluid in the machine tool in FIG. 6.

### DESCRIPTION OF THE PREFERRED EMBODIMENTS

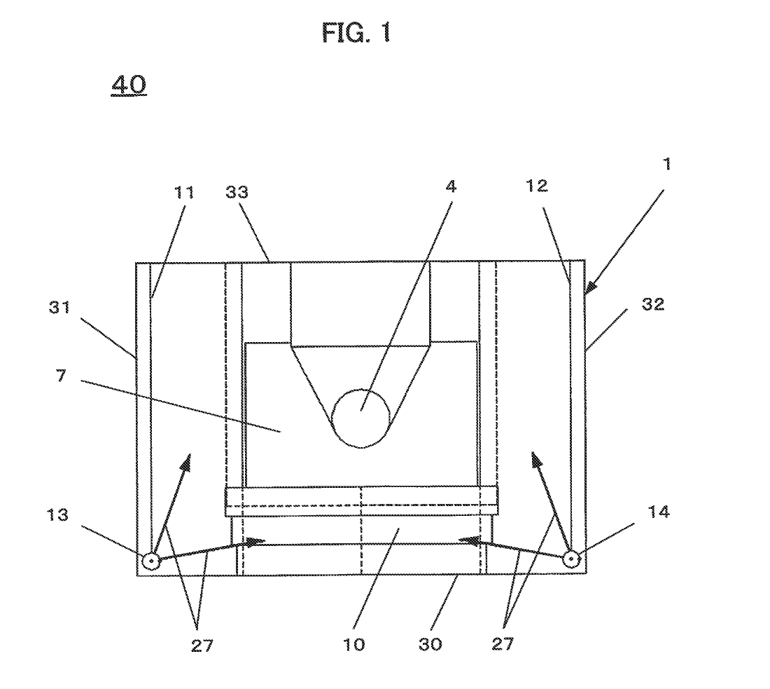

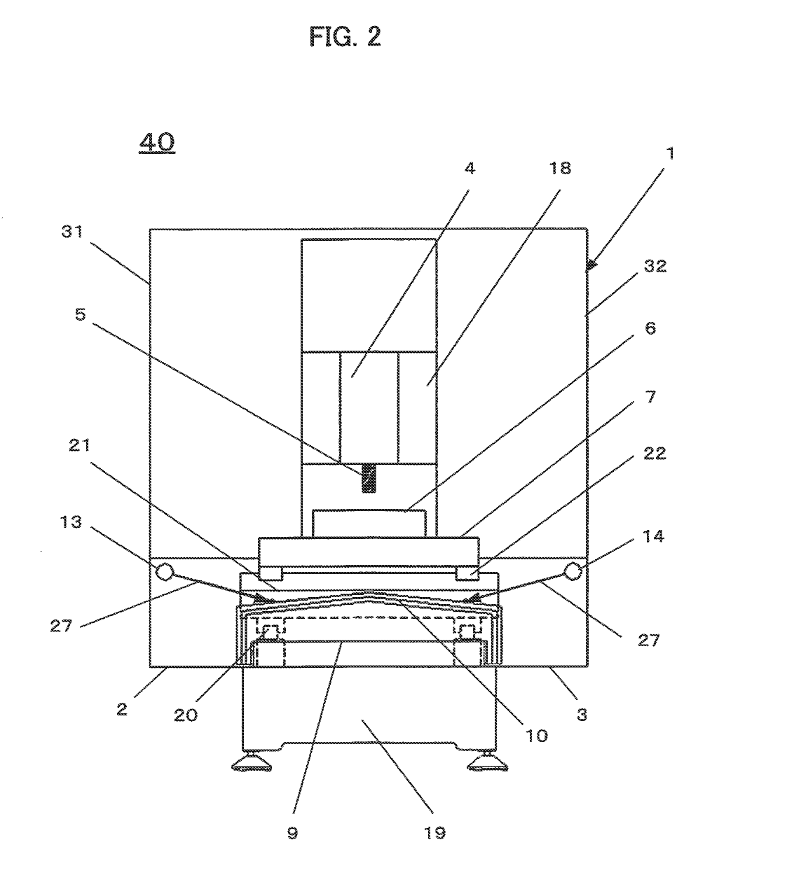

Firstly, a first embodiment of a machine tool according to the present invention will be described with reference to FIG. 1 and FIG. 2.

The cover 1 of the machine tool 40 is called a splash guard, and forms a machining space due to being distanced to the outer side of a saddle 21, a table 7, a column 18, a spindle 4 and a tool 5. The cover 1 is constituted by a front face cover 30 provided on a side opposing the column 18 via the table 7, front face covers 31, 32 provided on both the left and right side of the front face cover 30, a rear face cover 33, and a bottom section and ceiling cover. The bottom section of the cover 1 includes a first portion which connects a lower end of the front face cover 30 with a front end of the bed 19, a second portion which connects a lower end of the left side face cover 31 with a left end of the bed 19, and a third portion which connects a lower end of the right side face cover 32 with a right end of the bed 19. The first portion which constitutes the front face cover 30 and the bottom section of the cover 1, and the second and third portions which constitute the side face covers 31, 32 and the bottom section of the cover 1 may be made respectively from integrated members or from separate members. The ceiling cover is not depicted in the drawing.

The saddle 21 is supported on the bed 19 via a saddle movement mechanism 20, and a table 7 on which a workpiece 6 is loaded is supported on the saddle 21 via the table movement mechanism 22. Moreover, a column 18 is erected on the bed 19, and a spindle 4 on which a tool 5 is installed is fixed to an upper part of the column 18. The machine tool 40 performs cutting and machining of the workpiece 6 loaded on the table 7, by moving the spindle 4 and the table 7 relative to each other within the machining space. The saddle movement mechanism 20 and the table movement mechanism 22 are respectively constituted by rails and a guide which is guided by the rails. The direction of movement of the saddle 21 is a direction perpendicular to the drawing sheet of FIG. 2 (the front/rear direction of the machine tool 40), and the direction of movement of the table 7 is the left/right direction in FIG. 2 (the left/right direction of the machine tool 40), which is perpendicular to the direction of movement of the saddle 21.

In order to supply cutting fluid to the machining space which is distanced by the cover 1, a left cutting fluid supply flow channel 11 and a right cutting fluid supply flow channel 12 are arranged in the machining space. Cutting fluid is supplied to the left cutting fluid supply flow channel 11 and the right cutting fluid supply flow channel 12 from a cutting fluid supply apparatus (not illustrated) and via a flow channel (not illustrated). A first cutting fluid supply nozzle 13 is provided at a prescribed position in the left cutting fluid supply flow channel 11 and a second cutting fluid supply nozzle 14 is provided at a prescribed position in the right cutting fluid supply flow channel 12. Cutting fluid is discharged in a prescribed direction in the machining space, from the first and second cutting fluid supply nozzles 13, 14 (see cutting fluid flow 27). For example, cutting fluid is discharged onto the upper surface of the telescopic cover 10 and the upper surface on the bottom section of the cover 1 (the bottom surface of the cover 1).

In order to prevent accumulation of cutting chips generated during machining of the workpiece 6 by the tool 5, in the drive parts (rails, feed screw) of the saddle 21, a telescopic cover 10 is arranged between the saddle 21 and the front face cover 30 of the cover 1. The telescopic cover 10, one end of which is fixed to the saddle 21 and the other end of which is fixed to the front face cover 30, performs a telescopic motion in the front/rear direction in accordance with the movement of the saddle 21 with respect to the front face cover 30.

A wall section 9 is arranged in the bottom section of the cover 1, underneath the telescopic cover 10, so as not to interfere with the telescopic motion of the telescopic cover 10. This wall section 9 is composed from a block member having side walls provided on both the left and right sides on top of the bottom surface of the cover 1, the side walls having a prescribed height and extending long in the front/rear direction. The dimension (width) of the wall section 9 in the left/right direction is slightly smaller than the dimension (width) of the telescopic cover 10 in the left/right direction (the direction perpendicular to the telescoping direction of the telescopic cover 10). A portion of the bottom surface of the cover 1 which faces the lower side of the telescopic cover 10 and a portion of the bottom surface of the cover 1 which faces the outer side of the telescopic cover 10 are separated from each other by the left and right side faces (side walls) of the wall section 9. The height of the wall section 9 (the height of the side walls) is a height in a range that does not interfere with the telescoping action of the telescopic cover 10.

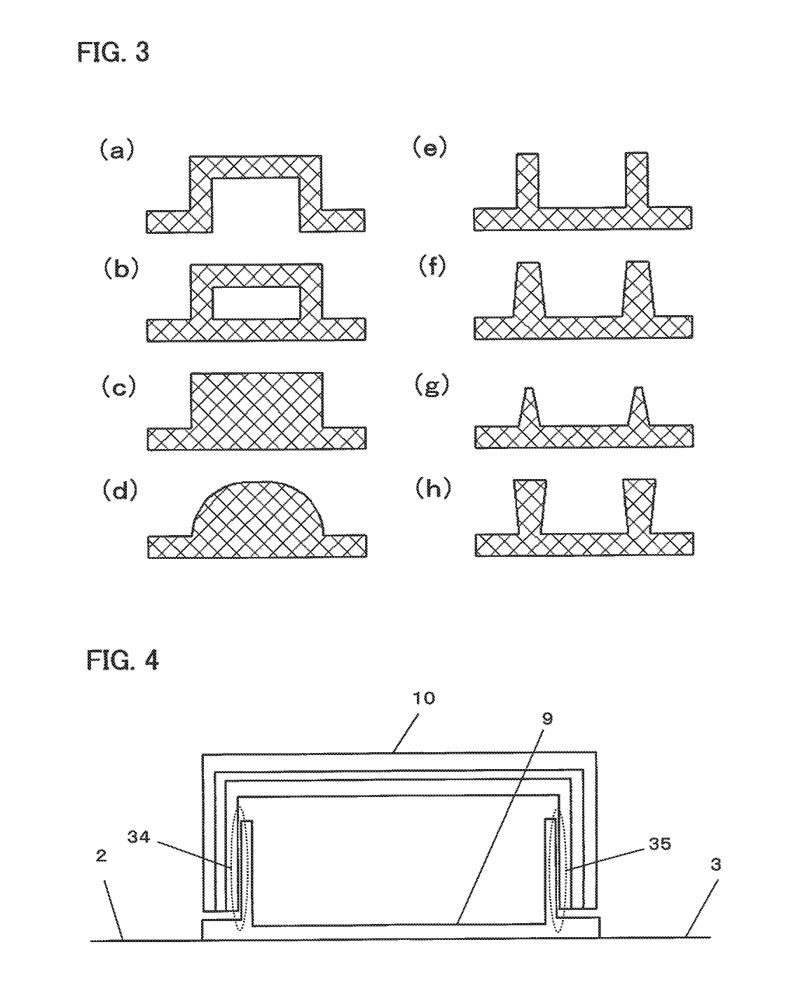

As stated previously, the wall section 9 is formed to have a width slightly smaller than that of the telescopic cover 10, and hence there is virtually no gap between the inner side surfaces of the side face sections of the telescopic cover 10 and the side walls of the wall section 9, as indicated by the dotted lines 34, 35 in FIG. 4. Reference numerals 2 and 3 in FIG. 4 indicate a left bottom surface and a right bottom surface which constitute the bottom surface of the cover 1. Furthermore, the wall section 9 shown in FIG. 4 has the shape indicated in (e) in FIG. 3, which is described below.

In this way, since the wall section 9 is arranged in the bottom section of the cover 1, underneath the lower side of the telescopic cover 10, it is possible to prevent cutting chips from entering into a space beneath the telescopic cover 10 and accumulating in the drive parts of the saddle 21 and the vicinity thereof. As shown in FIG. 4, since the gap between the telescopic cover 10 and the side faces of the wall section 9 (as indicated by the dotted lines 34, 35) is small, then it is possible to prevent cutting chips from entering into a space beneath the telescopic cover 10 and accumulating on the lower side of the telescopic cover 10.

As the structural examples depicted in the cross-sectional diagrams in (a) to (H) in FIG. 3 show, the wall section 9 may be formed of a block member provided with left and right side walls having a prescribed height and extending long in the front/rear direction (the direction perpendicular to the drawing sheet of FIG. 3), or the wall section 9 may be formed by raising up a portion of the bottom section of the cover 1 which faces the lower side of the telescopic cover 10 to form left and right side walls extending long in the front/rear direction. In other words, the wall section 9 may be installed on the bottom surface of the cover 1 as a separate member from the cover 1, or may have an integrated structure with (the bottom portion of) the cover 1 or the wall section 9 may be formed by raising up a portion of the bottom section of the cover 1 which faces the lower side of the telescopic cover 10.

FIG. 3 shows examples of the shape (cross-sectional shape) of the wall section 9. The wall sections 9 shown in (a) and (b) in FIG. 3 are constituted by left and right side walls and a ceiling which connects these left and right side walls. These left and right side walls are formed in such a manner that there is a slight gap between these side walls and the telescopic cover 10. In the wall section 9 shown in (c) and (d) in FIG. 3, the base section of the wall section 9 is raised up in a rectangular or elliptical cross-sectional shape, in such a manner that there are slight gaps respectively between the telescopic cover 10 and the left and right side walls of the raised up portions. The wall sections 9 shown in (e), (f), (g) and (h) in FIG. 3 are raised up in two wall portions (left and right wall portions) from the base section, in such a manner that slight gaps are formed respectively between the telescopic cover 10 and the side surfaces (left and right side walls) of the raised up wall portions.

Provided that the wall section 9 is arranged in the bottom section of the cover 1, underneath the lower side of the telescopic cover 10, so as not to interfere with the telescopic motion of the telescopic cover 10, and that cutting chips can be prevented from entering into a space beneath the telescopic cover 10 and accumulating in the drive parts (rail and feed screw) of the saddle 21, and the vicinity thereof, then it is possible to adopt any of the shapes shown in (a) to (h) in FIG. 3, or any other shape apart from these. Moreover, if the wall section 9 has a ceiling portion connecting the left and right side walls as shown in (a) to (d) in FIG. 3, then it is possible to adopt a structure which prevents accumulation of cutting chips by applying an inclination to this ceiling portion.

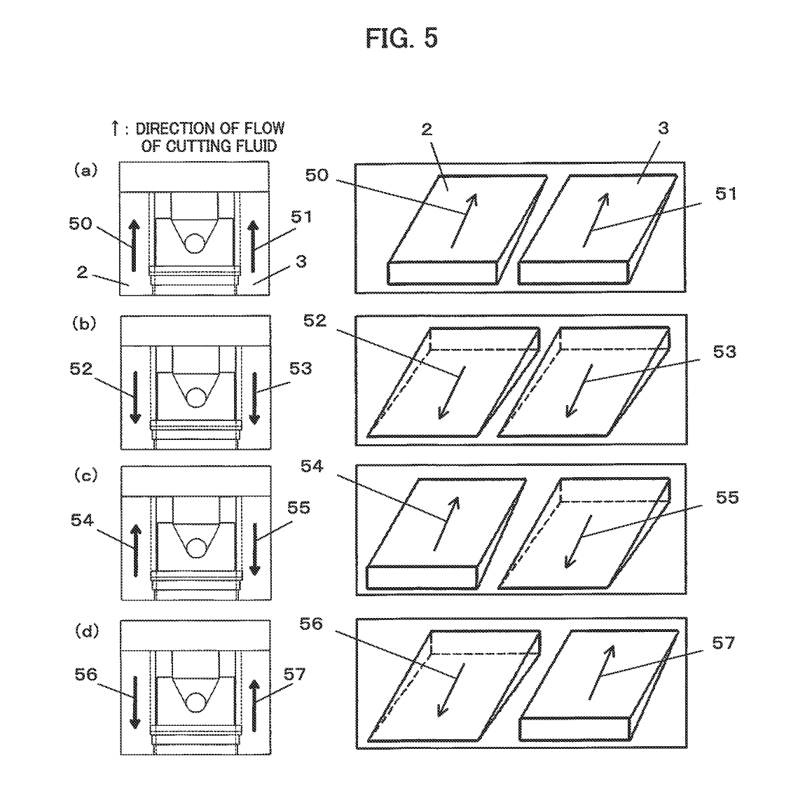

The direction of flow of the cutting fluid in the machine tool in FIG. 1 (first embodiment) will now be described with reference to FIG. 5.

In this embodiment, as shown in FIG. 5, the bottom surface of the cover 1 is demarcated into a left bottom surface 2 and a right bottom surface 3, the left bottom surface 2 is either inclined so as to become lower from the front towards the rear or inclined so as to become lower from the rear towards the front, and furthermore, the right bottom surface 3 is either inclined so as to become lower from the front towards the rear or inclined so as to become lower from the rear towards the front.

If the bottom surface of the cover 1 (left bottom surface 2, right bottom surface 3) is inclined from the front towards the rear or from the rear towards the front of the machine tool, as indicated by the arrows 50 to 57 on the right-side diagram in each of (a) to (d) in FIG. 5, then the cutting fluid flows in the directions indicated by the arrows 50 to 57 and is recovered in a cutting fluid recovery apparatus (not illustrated).

(a) in FIG. 5 is an example in which the left bottom surface 2 and the right bottom surface 3 are both inclined surfaces which become lower from the front towards the rear of the machine tool, (b) in FIG. 5 is an example in which the left bottom surface 2 and the right bottom surface 3 are both inclined surfaces which become lower from the rear towards to the front of the machine tool, and (c) and (d) in FIG. 5 are examples in which, of the left bottom surface 2 and the right bottom surface 3, one is an inclined surface which becomes lower from the front towards the rear of the machine tool and the other is an inclined surface which becomes lower from the rear towards to the front of the machine tool.

Cutting fluid is supplied to the upper surface of the telescopic cover 10, and the left bottom surface 2 and the right bottom surface 3 of the bottom section of the cover 1, removes the cutting chips which are accumulated there, and is discharged to the cutting fluid supply apparatus (not illustrated). If the wall section 9 is formed by raising up the bottom section of the cover (splash guard) 1 or the wall section 9 is installed on the bottom section of the cover 1, it is possible to supply cutting fluid to the wall section 9. If cutting fluid is supplied to a wall section of this kind, then as described above, an inclined surface may be provided on the upper surface of the wall section 9 so that cutting chips adhering thereon are readily washed off by the cutting fluid.

As described above, in this first embodiment, when cutting chips generated by machining by the machine tool accumulate on top of a telescopic cover 10 which is capable of a telescopic motion, then due to the telescopic motion of the telescopic cover which accompanies the movement of the saddle 21 with respect to the cover 1 (front face cover 30), and the supply of cutting fluid from the first and second cutting fluid supply nozzles 13, 14 provided on the left and right cutting fluid supply flow channels 11, 12, the cutting chips accumulated on the front surface of the telescopic cover 10 fall down onto the left bottom surface 2 or the right bottom surface 3 from the telescopic cover 10. By supplying cutting fluid from the left cutting fluid supply flow channel 11, the right cutting fluid supply flow channel 12, the first cutting fluid supply nozzle 13 and the second cutting fluid supply nozzle 14, the cutting chips which have fallen down onto the left bottom surface 2 or the right bottom surface 3 are discharged to the machining liquid supply apparatus.

Due to the cutting chips being expelled by the supply of cutting fluid described above, the cutting chips do not accumulate to the lower side of the telescopic cover 10, and the cutting chips can be kept away from the drive parts (the drive device of the saddle). Furthermore, since the space where the cutting chips can readily accumulate on the lower side of the telescopic cover 10 is eliminated, and cutting chips are also prevented from becoming attached to the rail and/or feed screw-drive parts, then it is possible to prevent defects in the machine tool and to improve reliability.

Consequently, the space in the front face portion under the telescopic cover 10 where cutting chips are liable to stagnate in the bottom section of the cover 1 is eliminated, and the cutting chips accumulated on the left and right bottom surfaces 2 and 3 are discharged reliably and efficiently and can be recovered into the cutting fluid processing apparatus (not illustrated). Furthermore, since the cutting chips are prevented from entering into the drive parts of the machine tool, it is possible to prevent a defect in the drive parts due to cutting chips.

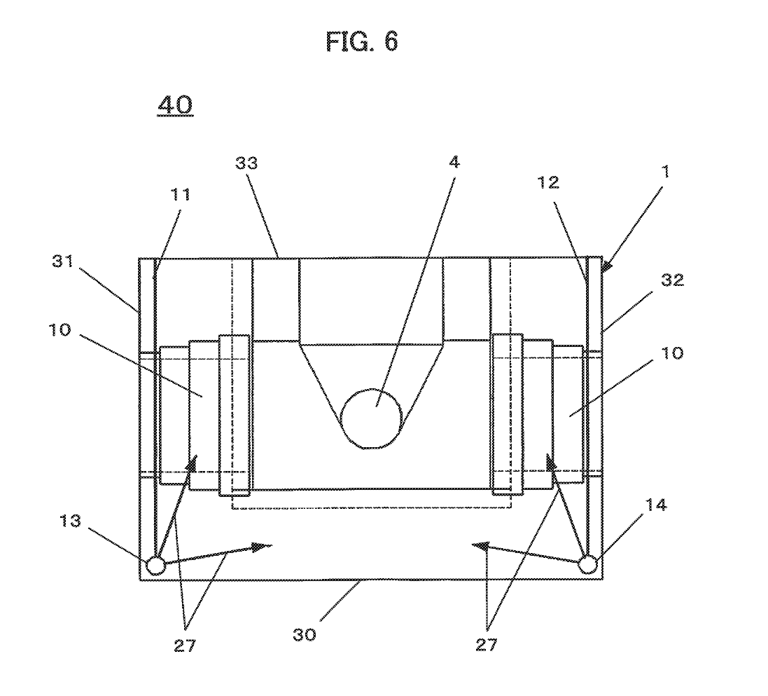

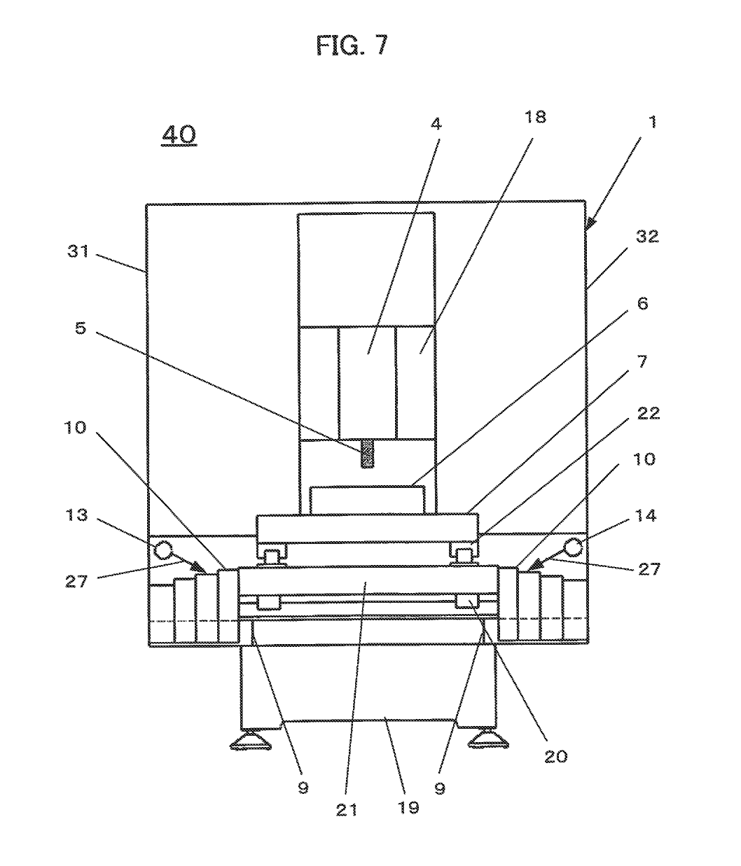

Next, a second embodiment of a machine tool according to the present invention will be described with reference to FIG. 6 and FIG. 7.

In the first embodiment described above, the direction of movement of the saddle 21 is the front/rear direction of the machine tool 40, the direction of movement of the table 7 is the left/right direction of the machine tool 40, which is perpendicular to the direction of movement of the saddle 21, one end of the telescopic cover 10 is fixed to the saddle 21, the other end thereof is fixed to the front face cover 30, and the telescopic cover 10 performs a telescopic motion in the front/rear direction in accordance with movement of the saddle 21 with respect to the front face cover 30. On the other hand, in this embodiment, the direction of movement of the saddle 21 is the left/right direction of the machine tool 40 (the left/right direction in FIG. 7), the direction of movement of the table 7 is the front/rear direction of the machine tool 40, which is perpendicular to the direction of movement of the saddle 21, one end of the telescopic cover 10 is fixed to the saddle 21, the other end thereof is fixed to the side face cover 31, 32, and the telescopic cover 10 performs a telescopic motion in the left/right direction in accordance with movement of the saddle 21 with respect to the front face cover 30.

At the bottom of the cover 1 and under the telescopic cover 10, the wall section 9 is arranged extending long in the left/right direction of the machine tool 40 and so as not to interfere with the telescopic motion of the telescopic cover 10. The dimension (width) of the wall section 9 in the front/rear direction is slightly smaller than the dimension (width) of the telescopic cover 10 in the front/rear direction (the direction perpendicular to the telescoping direction of the telescopic cover 10). A portion of the bottom surface of the cover 1 which faces the lower side of the telescopic cover 10 and a portion of the bottom surface of the cover 1 which faces the outer side of the telescopic cover 10 are separated from each other by the front and rear side faces (side walls) of the wall section 9. The height of the wall section 9 (the height of the side walls) is a height in a range that does not interfere with the telescopic motion of the telescopic cover 10.

In this way, since the wall section 9 is arranged in the bottom section of the cover 1, underneath the telescopic cover 10, it is possible to prevent cutting chips from entering into a space beneath the telescopic cover 10 and accumulating in the drive parts of the saddle 21 and the vicinity thereof. Since the gap between the telescopic cover 10 and the side faces of the wall section 9 is small, then it is possible to prevent cutting chips from entering into a space beneath the telescopic cover 10 and accumulating on the lower side of the telescopic cover 10.

Above, the arrangement of the telescopic cover 10 according to this embodiment, and the wall section 9 which is arranged in the bottom section of the cover 1, underneath the lower side of the telescopic cover 10, were described, the remainder of the composition being the same as the first embodiment described previously, and therefore description thereof is omitted here.

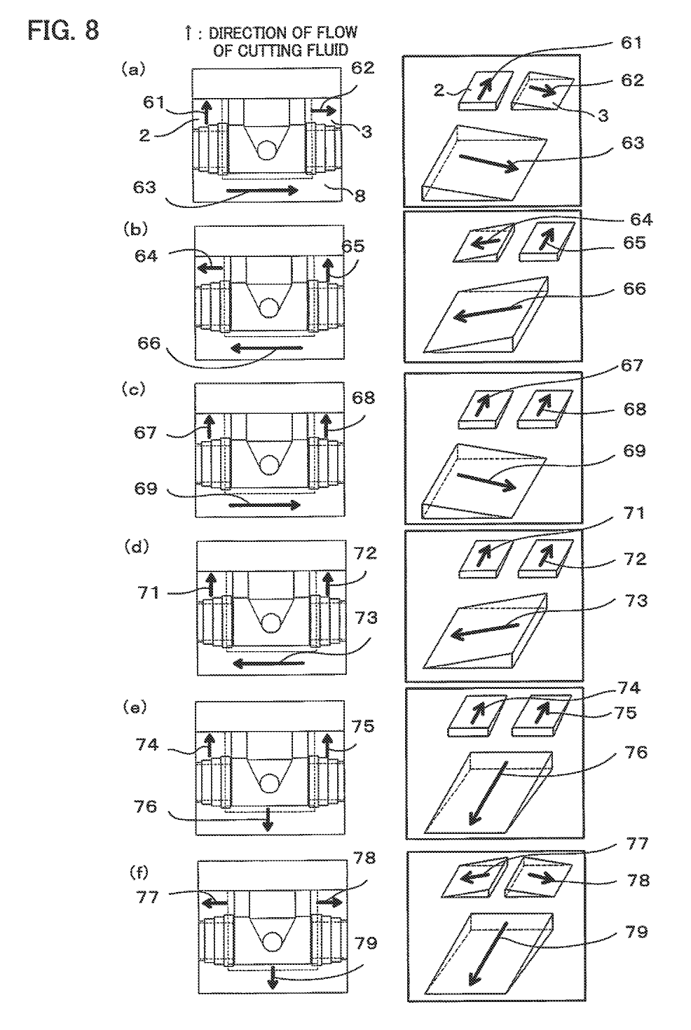

The direction of flow of the cutting fluid in the machine tool in FIG. 6 (second embodiment) will now be described with reference to FIG. 8.

In this embodiment, as shown in FIG. 8, the bottom surface of the cover 1 is demarcated into a front bottom surface 8, a left bottom surface 2 and a right bottom surface 3. The front bottom surface 8 is inclined so as to become lower in either one of the left and right directions, or so as to become lower from the rear towards the front (towards the front face cover 30), the left bottom surface 2 is inclined so as to become lower from the front towards the rear, or so as to become lower in the leftward direction (towards the left side face cover 31), and the right bottom surface 3 is inclined so as to become lower from the front towards the rear, or so as to become lower in the rightward direction (towards the right side face cover 32).

If the bottom surface of the cover 1 (front bottom surface 8, left bottom surface 2, and right bottom surface 3) is inclined from the front towards the rear or from the rear towards the front of the machine tool, or so as to become lower in either one of the left and right directions, as indicated by the arrows 61 to 79 on the right-side diagram in each of (a) to 8d) in FIG. 5, then the cutting fluid flows in the directions indicated by the arrows 61 to 79 and is recovered in a cutting fluid recovery apparatus (not illustrated).

1. A machine tool, comprising:
a saddle which is supported on a first guide member provided on a bed and which moves relatively in a first direction with respect to the bed;
a table which is supported on a second guide member provided on the saddle and which moves relatively with respect to the saddle in a second direction intersecting with the first direction;
a column having a spindle;
a cover which covers the periphery of the bed; and
a movable cover which is provided on both side faces or one side face in the first direction of the saddle, both ends or one end thereof being fixed to the cover and the movable cover being formed to be able to perform a telescopic motion in synchronization with the movement of the saddle, wherein
the cover has a front face cover provided on an opposite side to the column with the table interposed therebetween, side face covers provided to the left and right of the front face cover, and a bottom section which is connected to the bed from the front face cover and the side face covers, and
a workpiece is machined by causing a tool installed on the spindle and the workpiece which is set on the table to move relative to each other, and wherein
a wall section which projects upwards from the bottom section and extends long in the first direction is provided in the bottom section of the cover, inside the movable cover.

2. The machine tool according to claim 1, wherein the wall section is arranged inside the movable cover, by making a width of the wall section, in other words, a dimension of the wall section in a direction perpendicular to the first direction, slightly smaller than a width of the movable cover, in other words, a dimension perpendicular to the telescoping direction of the movable cover.

3. The machine tool according to claim 1, wherein the wall section is arranged so as to extend long in the front/rear direction or the left/right direction of the machine tool, in the bottom section of the cover.

4. The machine tool according to claim 1, wherein the wall section is attached to the bottom section of the cover as a separate member from the cover, or has a structure which is integrated with the cover, or is formed by raising up the bottom section of the cover.

5. The machine tool according to claim 1, wherein
the first direction is a direction parallel to the side face covers; and
a portion of the bottom section of the cover which connects with the side face covers has an inclined surface which becomes gradually lower from the front towards the rear of the machine tool or from the rear towards the front thereof.

6. The machine tool according to claim 1, wherein
the first direction is a direction parallel to the side face covers; and
portions of the bottom section of the cover which connect respectively with the left and right side face covers have inclined surfaces, one of which becomes gradually lower from the front towards the rear of the machine tool and the other one of which becomes gradually lower from the rear towards the front thereof.

7. The machine tool according to claim 1, wherein
the first direction is a direction parallel to the side face covers; and
a portion of the bottom section of the cover which connects with the front face cover and a portion of the bottom section of the cover which connects with the side face covers are separated by the wall section, and the separated portions each have an inclined surface which is inclined in any direction.

8. The machine tool according to claim 1, further comprising a cutting fluid supply nozzle which supplies cutting fluid to an upper surface of the movable cover which is able to perform a telescopic motion.

9. The machine tool according to claim 1, wherein a portion of the bottom section of the cover which connects with the front face cover and a portion of the bottom section of the cover which connects with the side face covers are separated by the wall section, and cutting fluid supply nozzles which respectively supply cutting fluid to the separated portions are provided.
